(19) United States
(12) Patent Application Publication
(10) Pub. No.: US 2024/0325254 A1
(43) Pub. Date: Oct. 3, 2024

(54) Easy Grip Baby Bottle Device

(71) Applicant: Kayla Williams, Newport, MI (US)

(72) Inventor: Kayla Williams, Newport, MI (US)

(21) Appl. No.: 18/609,091

(22) Filed: Mar. 19, 2024

Related U.S. Application Data
(60) Provisional application No. 63/492,489, filed on Mar. 28, 2023.

(51) Int. Cl. A61J 9/06

(52) U.S. Cl. CPC A61J 9/0623; A61J 9/0607

(57) ABSTRACT

A baby bottle grip device is disclosed for optimal gripping by a baby. The baby bottle grip device comprises a body component that is configured in a prolate spheroid shape. The body component would be plastic or rubber with a plurality of through-holes surrounding the exterior of the body component. The through-holes allow for gripping and make it easier for babies to grab and learn how to hold onto a bottle. The body component has a hollow, interior cavity and open ends for receiving a conventional baby bottle. The baby bottle is held within the body component via an interference fit. The body component can be manufactured in different sizes, depending on the size of the baby bottle to be held.

### CROSS-REFERENCE TO RELATED APPLICATION

The present application claims priority to, and the benefit of, U.S. Provisional Application No. 63/492,489, which was filed on Mar. 28, 2023, and is incorporated herein by reference in its entirety.

### FIELD OF THE INVENTION

The present invention relates generally to the field of baby bottle grip devices. More specifically, the present invention relates to a baby bottle within a hollow ball filled with a plurality of holes that allow a baby to obtain an easy grip. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in baby bottle grip devices. Generally, the design of a baby bottle is not conducive to a child being able to hold their own bottle. Further, the slippery exterior causes the bottle to fall through their grasp. This can result in parents and caretakers having to continuously retrieve and reposition the bottle. Often, parents typically end up feeding the child to make it a faster and less frustrating process. However, this does not allow children to work on their fine and gross motor skills.

It is generally known that the hands of infants are too small to firmly grip a conventional feeding bottle, i.e., a generally cylindrical bottle having a nipple end and a base end. In addition, infants often lack the physical coordination and strength to hold feeding bottles. Thus, it is needed to find ways to enable an infant to independently hold and support a feeding bottle and feed while the parent or person attending the infant may have both hands free to perform other tasks.

Accordingly, there is a demand for an improved baby bottle grip device that assists in feeding infants through a gripping device that enables an infant to hold and support a bottle while feeding. More particularly, there is a demand for a baby bottle grip device that provides a device that assists in allowing infants to feed themselves.

Therefore, there exists a long-felt need in the art for a baby bottle grip device that provides users with a baby bottle within a hollow ball filled with a plurality of holes that allow a baby to obtain an easy grip. There is also a long-felt need in the art for a baby bottle grip device that enables babies to work on fine and gross motor skills at a very young age. Further, there is a long-felt need in the art for a baby bottle grip device that offers a very attainable method for babies to learn to hold their own bottle with little assistance from parents. Moreover, there is a long-felt need in the art for a device that affords a sense of independence to young babies desiring to feed themselves. Further, there is a long-felt need in the art for a baby bottle grip device that eliminates the need for parents to hold the bottle for their child at all times. Finally, there is a long-felt need in the art for a baby bottle grip device that is available in different sizes based on the size of the bottle.

The subject matter disclosed and claimed herein, in one embodiment thereof, comprises a baby bottle grip device. The device is a baby feeding bottle with an exterior designed for optimal gripping by a baby. The baby bottle grip device comprises a body component that is configured in a prolate spheroid shape, such that it is a continuously curved three-dimensional object that is longer than it is around. The body component would be plastic or rubber with a plurality of through-holes surrounding the exterior of the body component. The through-holes allow for gripping and make it easier for babies to grab and learn how to hold onto a bottle. The body component has a hollow, interior cavity and open ends for receiving a conventional baby bottle. The baby bottle is held within the body component via an interference fit, such that the open ends are smaller than the diameter of the baby bottle, but the body component has enough stretch to securely retain the baby bottle within. The body component can be manufactured in different sizes, depending on the size of the baby bottle to be held.

In this manner, the baby bottle grip device of the present invention accomplishes all of the foregoing objectives and provides users with a device that allows young babies to feed themselves via a baby bottle. The device is available in different sizes based on the size of baby bottles used. The device can be manufactured of a plastic or rubber material.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a baby bottle grip device. The device is a baby feeding bottle with an exterior designed for optimal gripping by a baby. The baby bottle grip device comprises a body component that is configured in a prolate spheroid shape. The body component would have a plurality of through-holes surrounding the exterior. The through-holes allow for gripping and make it easier for babies to grab and learn how to hold onto a bottle. The body component has a hollow, interior cavity and open ends for receiving a conventional baby bottle. The baby bottle is held within the body component via an interference fit or other securing means.

In one embodiment, the baby bottle grip device of the present invention provides a bottle gripper for assisting infants in holding a bottle. The baby bottle grip device may be used with any conventional feeding bottle or any non-conventional feeding bottle of varying size, shape, circumference, or cross-sectional area. The baby bottle typically has a nipple end and a bottom end. Typically, conventional feeding bottles have a generally cylindrical or annular shape or a hexagonal shape in cross-section. The present device, however, can accommodate feeding bottles of any size or cross-sectional area, as long as the bottle can be held by the baby bottle grip device. Thus, the device allows a young baby to easily grasp the device while drinking from the bottle to aid in the promotion of fine and gross motor skills.

In one embodiment, the baby bottle grip device comprises a body component that is configured in a prolate spheroid shape, such that it is a continuously curved three-dimensional object that is longer than it is around. The body component can be any suitable size and shape as is known in the art, as long as it is sized and shaped to retain a conventional baby bottle within its interior, such as oval, elongated, etc. Further, the body component can be manufactured in different sizes and shapes, depending on the size of the baby bottle to be used. In one embodiment, the body component is bulged forward in the circumferential direction along the circumferential direction, so that an infant can easily grasp the device during use. Further, the body component is bulged forward along the circumferential direction, such that a void space is formed between the body component and the body of the baby bottle to serve as a buffer. Thus, even if the device is dropped on a body part of the infant, the impact applied to the infant can be buffered.

In one embodiment, the body component may be of any size, so long as it is capable of accommodating bottles of various sizes and shapes in use. Generally, the body component should be sufficiently large to provide good support for the bottle and yet not too large to prevent the infant from grasping the body component.

In one embodiment, the body component has an exterior surface, defining a hollow, interior cavity with open opposing first and second ends on either side of the body component. The open opposing first and second ends are sized and shaped to retain a conventional baby bottle. Thus, a baby bottle passes through the first end and into the hollow, interior cavity, then passes out the second open end. Thus, once in position for use, the nipple portion of the bottle is exposed out of the first end and the bottom portion of the bottle is exposed out of the opposing second end. That is, the open opposing first and second ends are formed symmetrically in the upward and downward directions with the hollow interior cavity interposed therebetween. The body of the baby bottle is accommodated in the interior cavity, with the ends of the bottle being exposed out of the first and second ends. Specifically, the nipple end is exposed out of the first end, such that an infant can engage the nipple to drink the liquid from within the body of the baby bottle. The liquid can be milk, formula, water, juice, etc., or any other suitable liquid as is known in the art.

In use, the baby bottle is held in place and can be firmly gripped by the baby bottle grip device by inserting the bottle into an interior cavity formed in the body component of the baby bottle grip device. The interior cavity extends completely through the body component from the first end to the second end. In the preferred embodiment, the interior cavity is located in the substantial center of the body component. However, the interior cavity may be located elsewhere in the body component so long as the body component can provide support for the feeding bottle and the infant can readily grasp the body component of the device, thereby providing independent support for the bottle during a feeding process.

In one embodiment, the interior cavity is located proximately in the center of the body component. The interior cavity includes a means for securing whereby inserting a feeding bottle into the interior cavity results in the interior cavity fitting snuggly around the peripheral surface of the bottle at any specified position along the length of the bottle in order to fixedly secure the body component on the bottle. Typically, the securing means is an interference fit with the device.

In one embodiment, the conventional baby bottle is held within the body component via an interference fit. Thus, the open opposing first and second ends are smaller than the diameter of the baby bottle, but the material of the body component has enough stretch to securely retain the baby bottle within. In use, the baby bottle can be easily inserted into the interior cavity via the first or second ends. The first and second ends are configured to stretch and flex to accept the baby bottle. Further, the diameter of the first and second ends is formed to be slightly smaller than the diameter of the body of the baby bottle, so that the baby bottle is securely fastened to the baby bottle, once inserted.

In one embodiment, the opening of the first and second ends and interior cavity is about 1.5 inches in diameter. This size opening has been found to accommodate a wide range of commercially available baby bottles. The opening extends through the entire body component, from its first end to its second end to accommodate the insertion of the bottles therein such that both the nipple end and bottom end of the bottle extend outwardly from the opposing first and second ends of the body component.

In one embodiment, the body component comprises a plurality of through-holes surrounding the exterior surface. The through-holes allow for gripping and make it easier for babies to grab and learn how to hold onto a bottle. The through-holes can be any suitable size and shape as is known in the art but are typically circular or oval and sized to retain at least one baby's finger. Any suitable number of through-holes can be utilized as is known in the art. Further, all of the exterior surface can comprise the plurality of through-holes, or only a portion of the exterior surface comprises the through-holes, such as a middle portion and/or a first end. Furthermore, in one embodiment, only the sides or elongated lengths can comprise the plurality of through-holes. Typically, the plurality of through-holes are arranged in a zig-zagged, honeycombed, or meshed configuration, but the through-holes can be arranged in any suitable configuration as is known in the art. Further, the through-hole is a portion of the exterior surface of the body component where at least one finger of the infant enters and exits. In another embodiment, the through-hole can be sized and shaped to retain two or more fingers of the infant. The through-holes are formed so that the infant's finger or fingers can be easily and securely gripped during use of the device.

In one embodiment, the body component of the present device may be fabricated of any suitable material and is not limited to a particular composition. For example, the body component may be fabricated of a hard or soft plastic, a hard or soft rubber, any man-made material (such as polyester, nylon, rayon, etc.,), a textured fabric, or the like. Preferably, suitable materials would be durable, easily cleaned, soft and pleasing to an infant, and non-toxic. However, in the preferred embodiment, the material composing the body component is made from a silicone or other suitable flexible material as is known in the art. The material should have enough elastomeric resilience to allow the body component to be deformed temporarily but not permanently. Furthermore, as the body component is in direct contact with the body of the infant, it should be made of a silicone material which is harmless to the human body.

In one embodiment, the device can be molded in various colors and patterns to match existing décor, sports teams, nursery themes, etc., based upon a user's preference.

In one embodiment, a rattle, shaker, bell, or any suitable noise-maker may be attached or sewn to the exterior surface of the body component, providing amusement for the infant. Further, the rattle, shaker, bell, or noise-maker may be freely detachable from the exterior surface, such that detaching the rattle, bell, shaker, etc., facilitates the cleaning of the body component.

In one embodiment, the present design allows the baby to hold the bottle at any selected position along the length of the bottle. This also permits a desired portion of the nipple end of the bottle to extend beyond the body component. Thus, the present device is adapted for use with a wide range of sizes of bottles and for use with bottles having a different shape in cross-sections such as circular, square, triangular, rectangular, etc.

In one embodiment, the present device allows the infant to feed without the aid of an adult because the infant can independently support the bottle through grasping of the body component. The present device also provides for a rattle to amuse the infant while feeding independently or otherwise.

In yet another embodiment, the baby bottle grip device comprises a plurality of indicia.

In yet another embodiment, a method of allowing a baby to easily grip a baby bottle during use is disclosed. The method includes the steps of providing a baby bottle grip device comprising a body component with a plurality of through-holes surrounding the exterior with an open interior cavity. The method also comprises inserting a conventional baby bottle within the open interior cavity. Further, the method comprises securing the baby bottle within the body component via an interference fit. Finally, the method comprises grasping the plurality of through-holes while drinking from the baby bottle.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the baby bottle grip device of the present invention showing the device in accordance with the disclosed architecture;

FIG. 2 illustrates a perspective view of one embodiment of the baby bottle grip device of the present invention showing the front of the device in accordance with the disclosed architecture;

FIG. 3 illustrates a perspective view of one embodiment of the baby bottle grip device of the present invention showing a baby holding the device in both hands in accordance with the disclosed architecture;

FIG. 4 illustrates a perspective view of one embodiment of the baby bottle grip device of the present invention showing a baby holding the device with one hand in accordance with the disclosed architecture;

FIG. 5 illustrates a perspective view of one embodiment of the baby bottle grip device of the present invention in use in accordance with the disclosed architecture; and

FIG. 6 illustrates a flowchart showing the method of allowing a baby to easily grip a baby bottle during use in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a baby bottle grip device that provides users with a baby bottle within a hollow ball filled with a plurality of holes that allow a baby to obtain an easy grip. There is also a long-felt need in the art for a baby bottle grip device that enables babies to work on fine and gross motor skills at a very young age. Further, there is a long-felt need in the art for a baby bottle grip device that offers a very attainable method for babies to learn to hold their own bottle with little assistance from parents. Moreover, there is a long-felt need in the art for a device that affords a sense of independence to young babies desiring to feed themselves. Further, there is a long-felt need in the art for a baby bottle grip device that eliminates the need for parents to hold the bottle for their child at all times. Finally, there is a long-felt need in the art for a baby bottle grip device that is available in different sizes based on the size of the bottle.

The present invention, in one exemplary embodiment, is a novel baby bottle grip device. The baby bottle grip device comprises a body component that is configured in a prolate spheroid shape. The body component would be plastic or rubber with a plurality of through-holes surrounding the exterior of the body component. The through-holes allow for gripping and make it easier for babies to grab and learn how to hold onto a bottle. The body component has a hollow, interior cavity and open ends for receiving a conventional baby bottle. The baby bottle is held within the body component via an interference fit. The present invention also includes a novel method of allowing a baby to easily grip a baby bottle during use. The method includes the steps of providing a baby bottle grip device comprising a body component with a plurality of through-holes surrounding the exterior with an open interior cavity. The method also comprises inserting a conventional baby bottle within the open interior cavity. Further, the method comprises securing the baby bottle within the body component via an interference fit. Finally, the method comprises grasping the plurality of through-holes while drinking from the baby bottle.

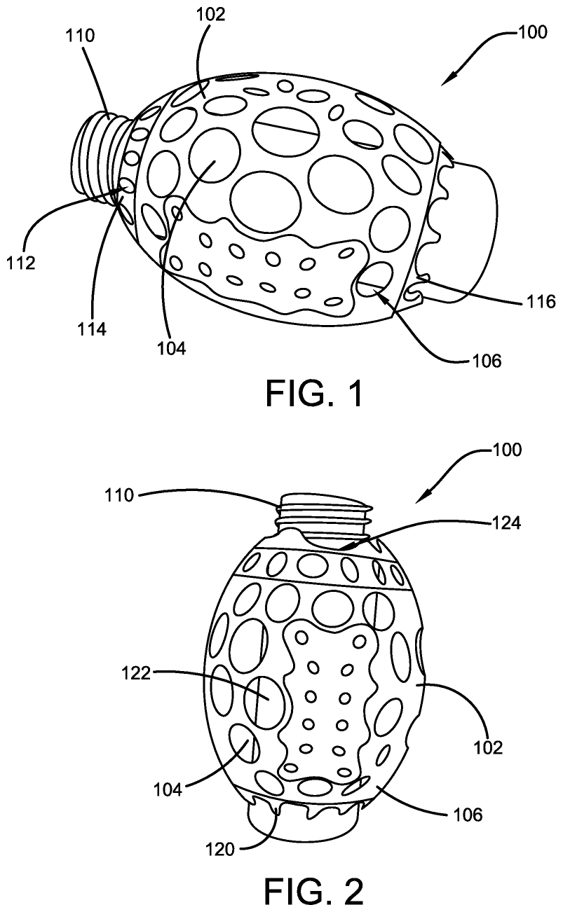

Referring initially to the drawings, FIG. 1 illustrates a perspective view of one embodiment of the baby bottle grip device 100 of the present invention. In the present embodiment, the baby bottle grip device 100 is an improved baby bottle grip device 100 that provides a baby feeding bottle 110 with an exterior designed for optimal gripping by a baby 108. Specifically, the baby bottle grip device 100 comprises a body component 102 with a plurality of through-holes 104 on the exterior surface 106. The through-holes 104 allow for gripping and make it easier for babies 108 to grab and learn how to hold onto a bottle 110. The body component 102 has a hollow, interior cavity 112 and open ends 114, 116 for receiving a conventional baby bottle 110. The baby bottle 110 is held within the body component 102 via an interference fit or other securing means.

Generally, the baby bottle grip device 100 of the present invention provides a bottle gripper for assisting infants 108 in holding a bottle 110. The baby bottle grip device 100 may be used with any conventional feeding bottle 110 or any non-conventional feeding bottle 110 of varying size, shape, circumference, or cross-sectional area. The baby bottle 110 typically has a nipple end 118 and a bottom end 120. Typically, conventional feeding bottles 110 have a generally cylindrical or annular shape or a hexagonal shape in cross-section. The present device 100, however, can accommodate feeding bottles 110 of any size or cross-sectional area, as long as the bottle 110 can be held by the baby bottle grip device 100. Thus, the device 100 allows a young baby 108 to easily grasp the device 100 while drinking from the bottle 110 to aid in the promotion of fine and gross motor skills.

Furthermore, the baby bottle grip device 100 comprises a body component 102 that is configured in a prolate spheroid shape, such that it is a continuously curved three-dimensional object that is longer than it is around. The body component 102 can be any suitable size and shape as is known in the art, as long as it is sized and shaped to retain a conventional baby bottle 110 within its interior, such as oval, elongated, etc. Further, the body component 102 can be manufactured in different sizes and shapes, depending on the size of the baby bottle 110 to be used. In one embodiment, the body component 102 is bulged forward in the circumferential direction along the circumferential direction, so that an infant 108 can easily grasp the device 100 during use. Further, the body component 102 is bulged forward along the circumferential direction, such that a void space is formed between the body component 102 and the body 122 of the baby bottle 110 to serve as a buffer. Thus, even if the device 100 is dropped on a body part of the infant 108, the impact applied to the infant 108 can be buffered.

Typically, the body component 102 may be of any size, so long as it is capable of accommodating bottles 110 of various sizes and shapes in use. Generally, the body component 102 should be sufficiently large to provide good support for the bottle 110 and yet not too large to prevent the infant 108 from grasping the body component 102.

Furthermore, the body component 102 has an exterior surface 106, defining a hollow, interior cavity 112 with open opposing first 114 and second 116 ends on either side of the body component 102. The open opposing first 114 and second 116 ends are sized and shaped to retain a conventional baby bottle 110. Thus, a baby bottle 110 passes through the first end 114 and into the hollow, interior cavity 112, then passes out the second 116 open end. Thus, once in position for use, the nipple portion 118 of the bottle 110 is exposed out of the first end 114 and the bottom portion 120 of the bottle 110 is exposed out of the opposing second 116 end. That is, the open opposing first 114 and second 116 ends are formed symmetrically in the upward and downward directions with the hollow interior cavity 112 interposed therebetween. The body 122 of the baby bottle 110 is accommodated in the interior cavity 112, with the ends 118, 120 of the bottle 110 being exposed out of the first 114 and second 116 ends. Specifically, the nipple end 118 is exposed out of the first end 114, such that an infant 108 can engage the nipple 118 to drink the liquid from within the body 122 of the baby bottle 110. The liquid can be milk, formula, water, juice, etc., or any other suitable liquid as is known in the art.

As shown in FIG. 2, in use, the baby bottle 110 is held in place and can be firmly gripped by the baby bottle grip device 100 by inserting the bottle 110 into an interior cavity 112 formed in the body component 102 of the baby bottle grip device 100. The interior cavity 112 extends completely through the body component 102 from the first end 114 to the second end 116. In the preferred embodiment, the interior cavity 112 is located in the substantial center of the body component 102. However, the interior cavity 112 may be located elsewhere in the body component 102 so long as the body component 102 can provide support for the feeding bottle 110 and the infant 108 can readily grasp the body component 102 of the device 100, thereby providing independent support for the bottle 110 during a feeding process.

In one embodiment, the interior cavity 112 is located proximately in the center of the body component 102. The interior cavity 112 includes a means for securing whereby inserting a feeding bottle 110 into the interior cavity 112 results in the interior cavity 112 fitting snuggly around the peripheral surface of the bottle 110 at any specified position along the length of the bottle 110 in order to fixedly secure the body component 102 on the bottle 110. Typically, the securing means is an interference fit with the device 100.

Accordingly, the conventional baby bottle 110 is held within the body component 102 via an interference fit. Thus, the open opposing first 114 and second 116 ends are smaller than the diameter of the baby bottle 110, but the material of the body component 102 has enough stretch to securely retain the baby bottle 110 within. In use, the baby bottle 110 can be easily inserted into the interior cavity 112 via the first 114 or second 116 ends. The first 114 and second 116 ends are configured to stretch and flex to accept the baby bottle 110. Further, the diameter of the first 114 and second 116 ends is formed to be slightly smaller than the diameter of the body 122 of the baby bottle 110, so that the baby bottle 110 is securely fastened to the body component 102, once inserted.

In one embodiment, the opening 124 of the first 114 and second 116 ends and interior cavity 112 is about 1.5 inches in diameter. This size opening 124 has been found to accommodate a wide range of commercially available baby bottles 110. The opening 124 extends through the entire body component 102, from its first end 114 to its second end 116 to accommodate the insertion of the bottles 110 therein such that both the nipple end 118 and bottom end 120 of the bottle 110 extend outwardly from the opposing first 114 and second 116 ends of the body component 102.

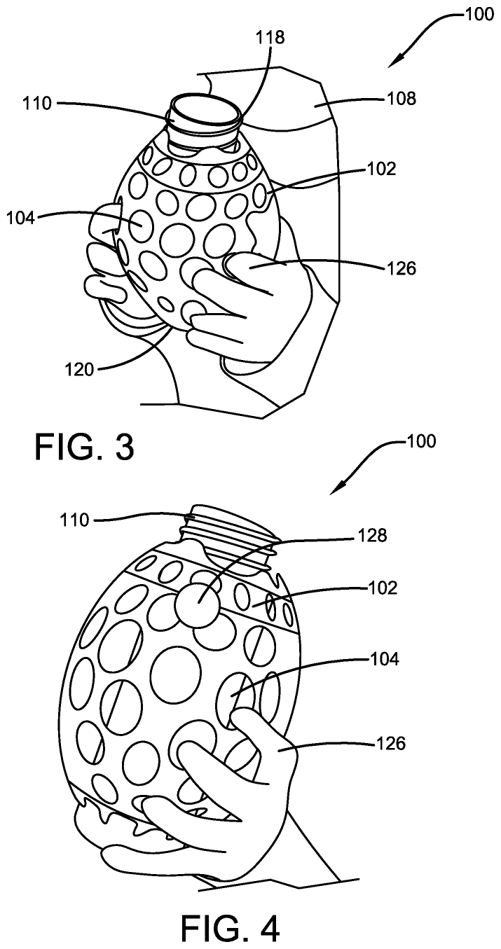

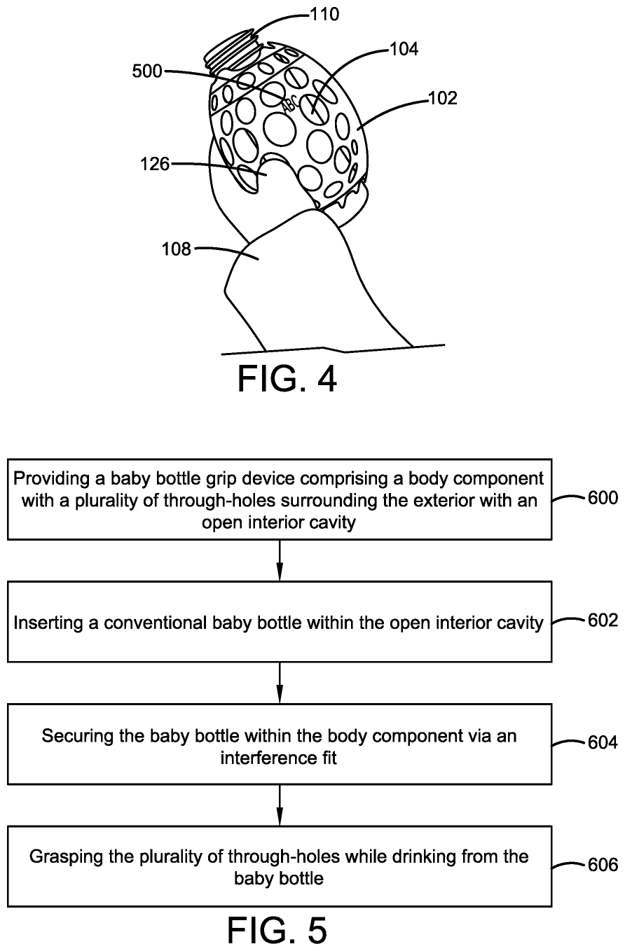

As shown in FIGS. 3-4, the body component 102 comprises a plurality of through-holes 104 surrounding the exterior surface 106. The through-holes 104 allow for gripping and make it easier for babies 108 to grab and learn how to hold onto a bottle 110. The through-holes 104 can be any suitable size and shape as is known in the art but are typically circular or oval and sized to retain at least one baby's finger 126. Any suitable number of through-holes 104 can be utilized as is known in the art. Further, all of the exterior surface 106 can comprise the plurality of through-holes 104, or only a portion of the exterior surface 106 comprises the through-holes 104, such as a middle portion and/or a first end. Furthermore, in one embodiment, only the sides or elongated lengths can comprise the plurality of through-holes 104. Typically, the plurality of through-holes 104 are arranged in a zig-zagged, honeycombed, or meshed configuration, but the through-holes 104 can be arranged in any suitable configuration as is known in the art. Further, the through-hole 104 is a portion of the exterior surface 106 of the body component 102 where at least one finger 126 of the infant 108 enters and exits. In another embodiment, the through-hole 104 can be sized and shaped to retain two or more fingers 126 of the infant 108. The through-holes 104 are formed so that the infant's finger 126 or fingers 126 can be easily and securely gripped during use of the device 100.

As shown in FIG. 5, the body component 102 of the present device 100 may be fabricated of any suitable material and is not limited to a particular composition. For example, the body component 102 may be fabricated of a hard or soft plastic, a hard or soft rubber, any man-made material (such as polyester, nylon, rayon, etc.,), a textured fabric, or the like. Preferably, suitable materials would be durable, easily cleaned, soft and pleasing to an infant 108, and non-toxic. However, in the preferred embodiment, the material composing the body component 102 is made from a silicone or other suitable flexible material as is known in the art. The material should have enough elastomeric resilience to allow the body component 102 to be deformed temporarily but not permanently. Furthermore, as the body component 102 is in direct contact with the body of the infant 108, it should be made of a silicone material which is harmless to the human body.

Further, the device 100 can be molded in various colors and patterns to match existing décor, sports teams, nursery themes, etc., based upon a user's preference.

In one embodiment, a rattle, shaker, bell, or any suitable noise-maker 128 may be attached or sewn to the exterior surface 106 of the body component 102, providing amusement for the infant 108. Further, the rattle, shaker, bell, or noise-maker 128 may be freely detachable from the exterior surface 106, such that detaching the rattle, bell, shaker, etc., 128, facilitates the cleaning of the body component 102.

Typically, the present design allows the baby 108 to hold the bottle 110 at any selected position along the length of the bottle 110. This also permits a desired portion of the nipple end 118 of the bottle 110 to extend beyond the body component 102. Thus, the present device 100 is adapted for use with a wide range of sizes of bottles 110 and for use with bottles 110 having a different shape in cross-sections such as circular, square, triangular, rectangular, etc.

Further, the present device 100 allows the infant 108 to feed without the aid of an adult because the infant 108 can independently support the bottle 110 through grasping of the body component 102. The present device 100 also provides for a rattle 128 to amuse the infant 108 while feeding independently or otherwise.

In yet another embodiment, the baby bottle grip device 100 comprises a plurality of indicia 500. The body component 102 of the device 100 may include advertising, a trademark, or other letters, designs, or characters, printed, painted, stamped, or integrated into the body component 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be a baby bottle, grip, or brand related.

FIG. 6 illustrates a flowchart of the method of allowing a baby to easily grip a baby bottle during use. The method includes the steps of at 600, providing a baby bottle grip device comprising a body component with a plurality of through-holes surrounding the exterior with an open interior cavity. The method also comprises at 602, inserting a conventional baby bottle within the open interior cavity. Further, the method comprises at 604, securing the baby bottle within the body component via an interference fit. Finally, the method comprises at 606, grasping the plurality of through-holes while drinking from the baby bottle.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “baby bottle grip device”, “baby bottle device”, “grip device”, and “device” are interchangeable and refer to the baby bottle grip device 100 of the present invention.

Notwithstanding the foregoing, the baby bottle grip device 100 of the present invention can be of any suitable size and configuration as is known in the art without affecting the overall concept of the invention, provided that it accomplishes the above-stated objectives. One of ordinary skill in the art will appreciate that the baby bottle grip device 100 as shown in FIGS. 1-6 is for illustrative purposes only, and that many other sizes and shapes of the baby bottle grip device 100 are well within the scope of the present disclosure. Although the dimensions of the baby bottle grip device 100 are important design parameters for user convenience, the baby bottle grip device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A baby bottle grip device that provides a user with a baby feeding bottle with an exterior designed for optimal gripping by a baby, the baby bottle grip device comprising:
a body component;
wherein the body component receives a baby bottle;
wherein the body component comprises a plurality of through-holes; and
further wherein the plurality of through-holes allows for gripping and make it easier for a baby to grab and learn how to hold onto a baby bottle on their own.

2. The baby bottle grip device of claim 1, wherein the baby bottle can be any conventional feeding bottle with a nipple end and a bottom end.

3. The baby bottle grip device of claim 2, wherein the body component is configured in a prolate spheroid shape.

4. The baby bottle grip device of claim 3, wherein the body component has an exterior surface, defining a hollow, interior cavity with open opposing first and second ends on either side of the body component.

5. The baby bottle grip device of claim 4, wherein the open opposing first and second ends are sized and shaped to retain the baby bottle, such that the baby bottle passes through the first end and into the hollow, interior cavity, then passes out the second end.

6. The baby bottle grip device of claim 5, wherein once in position for use, the nipple end of the baby bottle is exposed out of the first end and the bottom end of the baby bottle is exposed out of the opposing second end.

7. The baby bottle grip device of claim 6, wherein the baby bottle is held within the body component via an interference fit, such that the open opposing first and second ends are smaller than the diameter of the baby bottle, but material of the body component has enough stretch to securely retain the baby bottle within.

8. The baby bottle grip device of claim 7, wherein the plurality of through-holes are arranged in a zig-zagged, honeycombed, or meshed configuration.

9. The baby bottle grip device of claim 8, wherein each of the plurality of through-holes is a portion of the exterior surface of the body component where at least one finger of the baby enters and exits.

10. The baby bottle grip device of claim 9, wherein the body component is manufactured of silicone.

11. The baby bottle grip device of claim 10, wherein the body component is manufactured in a variety of sizes.

12. A baby bottle grip device that provides a user with a baby feeding bottle with an exterior designed for optimal gripping by a baby, the baby bottle grip device comprising:
a body component configured in a prolate spheroid shape;
wherein the body component receives a baby bottle;
wherein the baby bottle can be any conventional feeding bottle with a nipple end and a bottom end;
wherein the body component has an exterior surface, defining a hollow, interior cavity with open opposing first and second ends on either side of the body component;
wherein the open opposing first and second ends are sized and shaped to retain the baby bottle, such that the baby bottle passes through the first end and into the hollow, interior cavity, then passes out the second end;
wherein once in position for use, the nipple end of the baby bottle is exposed out of the first end and the bottom end of the baby bottle is exposed out of the opposing second end;
wherein the body component comprises a plurality of through-holes arranged in a zig-zagged, honeycombed, or meshed configuration; and
further wherein the plurality of through-holes allows for gripping and make it easier for a baby to grab and learn how to hold onto a baby bottle on their own.

13. The baby bottle grip device of claim 12, wherein a rattle, shaker, or bell is attached or sewn to the exterior surface of the body component, providing amusement for the baby.

14. The baby bottle grip device of claim 13, wherein the rattle, shaker, or bell is freely detachable from the exterior surface, such that detaching the rattle, shaker, or bell facilitates cleaning of the body component.

15. The baby bottle grip device of claim 12 further comprising a plurality of indicia.

16. The baby bottle grip device of claim 12, wherein the body component is adapted for use with a wide range of sizes of baby bottles and for use with baby bottles having a different shape in cross-sections such as circular, square, triangular, or rectangular.

17. The baby bottle grip device of claim 12, wherein the body component allows the baby to feed without aid of an adult because the baby can independently support the baby bottle through grasping of the body component.

18. The baby bottle grip device of claim 12, wherein the baby bottle is held within the body component via an interference fit, such that the open opposing first and second ends are smaller than diameter of the baby bottle, but material of the body component has enough stretch to securely retain the baby bottle within.

19. The baby bottle grip device of claim 12, wherein each of the plurality of through-holes is a portion of the exterior surface of the body component where at least one finger of the baby enters and exits.

20. A method of allowing a baby to easily grip a baby bottle during use, the method comprising the following steps:
providing a baby bottle grip device comprising a body component with a plurality of through-holes surrounding the exterior with an open interior cavity;
inserting a conventional baby bottle within the open interior cavity;
securing the baby bottle within the body component via an interference fit; and
grasping the plurality of through-holes while drinking from the baby bottle.
